(19) United States
(12) Patent Application Publication
(10) Pub. No.: US 2018/0199137 A1
(43) Pub. Date: Jul. 12, 2018

(54) Distributed Audio Microphone Array and Locator Configuration

(71) Applicant: Nokia Technologies Oy, Espoo (FI)

(72) Inventors: Sujeet Shyamsundar MATE, Tampere (FI); Veli-Matti KOLMONEN, Espoo (FI); Arto LEHTINIEMI, Lempaala (FI); Antti ERONEN, Tampere (FI)

(21) Appl. No.: 15/742,297

(22) PCT Filed: Jul. 5, 2016
(86) PCT No.: PCT/FI2016/050497

§ 371 Date: Jan. 5, 2018

(30) Foreign Application Priority Data
Jul. 8, 2015 (GB) 1511949.8
Jul. 27, 2015 (GB) 1513198.0
Oct. 12, 2015 (GB) 1518023.5
Oct. 12, 2015 (GB) 1518025.0
Nov. 30, 2015 (GB) 1521102.2

(51) Int. Cl. H04R 5/027; H04S 7/00

(52) U.S. Cl. CPC H04R 5/027; H04S 2400/15; H04S 7/303

(57) ABSTRACT

Apparatus including: a plurality of microphones arranged in a geometry around a first axis such that the apparatus is configured to capture sound from predetermined directions around the formed geometry; a locator configured to receive at least one remote location signal such that the apparatus may locate an audio source associated with a tag generating the remote location signal, the locator including an array of antenna elements, the antenna elements being arranged around the first axis; and a mount configured to mechanically couple the plurality of microphones and the locator.

### FIELD

The present application relates to apparatus and methods for distributed audio capture and mixing. The invention further relates to, but is not limited to, apparatus and methods for distributed audio capture and mixing for spatial processing of audio signals to enable spatial reproduction of audio signals.

### BACKGROUND

Capture of audio signals from multiple sources and mixing of those audio signals when these sources are moving in the spatial field requires significant manual effort. For example the capture and mixing of an audio signal source such as a speaker or artist within an audio environment such as a theatre or lecture hall to be presented to a listener and produce an effective audio atmosphere requires significant investment in equipment and training.

A commonly implemented system would be for a professional producer to utilize a close microphone, for example a Lavalier microphone worn by the user or a microphone attached to a boom pole to capture audio signals close to the speaker or other sources, and then manually mix this captured audio signal with one or more suitable spatial (or environmental or audio field) audio signals such that the produced sound comes from an intended direction.

The spatial capture apparatus or omni-directional content capture (OCC) devices should be able to capture high quality audio signal while being able to track the close microphones.

### SUMMARY

According to a first aspect there is provided an apparatus comprising: a plurality of microphones arranged in a geometry around a first axis such that the apparatus is configured to capture sound from pre-determined directions around the formed geometry; a locator configured to receive at least one remote location signal such that the apparatus may locate an audio source associated with a tag generating the remote location signal, the locator comprising an array of antenna elements, the antenna elements being arranged around the first axis; and a mount configured to mechanically couple the plurality of microphones and the locator.

The mount may be configured to provide an offset perpendicular to the first axis between the plurality of microphones and the locator.

The mount may be a telescopic mount configured to adjustably change the offset perpendicular to the first axis.

The plurality of microphones may be arranged in a first ring around the first axis, the locator may comprise the antenna elements arranged in a second ring around the first axis, wherein the first ring may be located above the second ring.

The plurality of microphones may be arranged in a first ring around the first axis, the locator may comprise the antenna elements arranged in a second ring around the first axis, wherein the first ring may be located below the second ring.

The plurality of microphones may be arranged in a first ring around the first axis, the locator may comprise the antenna elements arranged in a second ring around the first axis, wherein the first ring may be located outside the second ring.

The plurality of microphones may be arranged in a first ring around the first axis, the locator may comprise the antenna elements arranged in a second ring around the first axis, wherein the first ring may be located inside the second ring.

The plurality of microphones may be further configured to have a first reference orientation and the locator may be further configured to have a second reference orientation, wherein the mount may be configured to define an orientation offset between the first reference orientation and the second reference orientation.

The mount may be configured to align the first reference orientation and the second reference orientation.

The locator antenna elements may be configured to produce a 360 degree azimuth coverage around the first axis.

The plurality of microphones may be configured to produce a 360 degree azimuth coverage around the first axis.

The tag may be associated with at least one remote microphone configured to generate at least one remote audio signal from the audio source, wherein the apparatus may be configured to receive the remote audio signal.

The tag may be associated with at least one external microphone configured to generate an external audio signal from the audio source, wherein the apparatus may configured to transmit the audio source location to a further apparatus, the further apparatus may be configured to receive the external audio signal.

According to a second aspect there is provided a method comprising: providing a plurality of microphones arranged in a geometry around a first axis such that the microphones are configured to capture sound from pre-determined directions around the formed geometry; providing a locator for receiving at least one remote location signal, and locating an audio source associated with a tag generating the remote location signal, the locator comprising an array of antenna elements, the antenna elements being arranged around the first axis; and providing a mount configured to mechanically couple the plurality of microphones and the locator.

The mount may be configured to provide an offset perpendicular to the first axis between the plurality of microphones and the locator.

The mount may be a telescopic mount configured to adjustably change the offset perpendicular to the first axis.

The method may further comprise: arranging the plurality of microphones in a first ring around the first axis; arranging the antenna elements in a second ring around the first axis, wherein the first ring may be located above the second ring.

The method may further comprise: arranging the plurality of microphones in a first ring around the first axis; arranging the antenna elements in a second ring around the first axis, wherein the first ring may be located below the second ring.

The method may further comprise: arranging the plurality of microphones in a first ring around the first axis; arranging the antenna elements in a second ring around the first axis, wherein the first ring may be located outside the second ring.

The method may further comprise: arranging the plurality of microphones in a first ring around the first axis; arranging the antenna elements in a second ring around the first axis, wherein the first ring is located inside the second ring.

The plurality of microphones may further be configured to have a first reference orientation and the locator may further be configured to have a second reference orientation, wherein the method may comprise defining with the mount an orientation offset between the first reference orientation and the second reference orientation.

The method may further comprising aligning using the mount the first reference orientation and the second reference orientation.

The method may comprise producing a 360 degree azimuth coverage around the first axis using the locator antenna elements.

The method may comprise producing a 360 degree azimuth coverage around the first axis using the plurality of microphones.

The tag may be associated with at least one remote microphone configured to generate at least one remote audio signal from the audio source, wherein the method may comprise receiving the remote audio signal.

The tag may be associated with at least one external microphone configured to generate an external audio signal from the audio source, wherein the method may comprise transmitting the audio source location to a further apparatus, the further apparatus configured to receive the external audio signal.

According to a third aspect there is provided an apparatus comprising: means for arranging a plurality of microphones in a geometry around a first axis such that the microphones are configured to capture sound from pre-determined directions around the formed geometry; means for arranging a locator for receiving at least one remote location signal, and means for locating an audio source associated with a tag generating the remote location signal, the locator comprising an array of antenna elements, the antenna elements being arranged around the first axis; and means for mechanically coupling the plurality of microphones and the locator.

The means for mechanically coupling the plurality of microphones and the locator may be configured to provide an offset perpendicular to the first axis between the plurality of microphones and the locator.

The means for mechanically coupling the plurality of microphones and the locator may be a telescopic mount configured to adjustably change the offset perpendicular to the first axis.

The means for mechanically coupling the plurality of microphones and the locator may further comprise: means for arranging the plurality of microphones in a first ring around the first axis; means for arranging the antenna elements in a second ring around the first axis, wherein the first ring may be located above the second ring.

The means for mechanically coupling the plurality of microphones and the locator may further comprise: means for arranging the plurality of microphones in a first ring around the first axis; means for arranging the antenna elements in a second ring around the first axis, wherein the first ring may be located below the second ring.

The means for mechanically coupling the plurality of microphones and the locator may further comprise: means for arranging the plurality of microphones in a first ring around the first axis; means for arranging the antenna elements in a second ring around the first axis, wherein the first ring may be located outside the second ring.

The means for mechanically coupling the plurality of microphones and the locator may further comprise: means for arranging the plurality of microphones in a first ring around the first axis; means for arranging the antenna elements in a second ring around the first axis, wherein the first ring is located inside the second ring.

The plurality of microphones may further be configured to have a first reference orientation and the locator may further be configured to have a second reference orientation, wherein the means for mechanically coupling the plurality of microphones and the locator may further comprise means for defining with the mount an orientation offset between the first reference orientation and the second reference orientation.

The means for mechanically coupling the plurality of microphones and the locator may further comprise aligning using the mount the first reference orientation and the second reference orientation.

The apparatus may comprise the means for arranging a locator producing a 360 degree azimuth coverage around the first axis using the locator antenna elements.

The apparatus may comprise the means for arranging a plurality of microphones producing a 360 degree azimuth coverage around the first axis using the plurality of microphones.

The tag may be associated with at least one remote microphone configured to generate at least one remote audio signal from the audio source, wherein the apparatus may comprise means for receiving the remote audio signal.

The tag may be associated with at least one external microphone configured to generate an external audio signal from the audio source, wherein the method may comprise transmitting the audio source location to a further apparatus, the further apparatus may comprise means for receiving the external audio signal.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows schematically capture and render apparatus suitable for implementing spatial audio capture and rendering according to some embodiments;

FIG. 2 shows a first example spatial audio capture and locator apparatus comprising 3 locators according to some embodiments;

FIG. 3 shows a second example spatial audio capture and locator apparatus comprising 4 locators according to some embodiments;

FIG. 4 shows schematically an elevation and plan of an offset spatial audio capture and locator apparatus configuration according to some embodiments;

FIG. 5 shows schematically a local microphone and spatial microphone configuration according to some embodiments; and

FIG. 6 shows schematically an example device suitable for implementing the capture and/or render apparatus shown in FIG. 1.

### EMBODIMENTS OF THE APPLICATION

The following describes in further detail suitable apparatus and possible mechanisms for the provision of effective capture of audio signals from multiple sources and mixing of those audio signals. In the following examples, audio signals and audio capture signals are described. However it would be appreciated that in some embodiments the apparatus may be part of any suitable electronic device or apparatus configured to capture an audio signal or receive the audio signals and other information signals.

As described previously a conventional approach to the capturing and mixing of audio sources with respect to an audio background or environment audio field signal would be for a professional producer to utilize a close microphone (for example a Lavalier microphone worn by the user or a microphone attached to a boom pole) to capture audio signals close to the audio source, and further utilize a omnidirectional object capture microphone to capture an environmental audio signal. These signals or audio tracks may then be manually mixed to produce an output audio signal such that the produced sound features the audio source coming from an intended (though not necessarily the original) direction.

As would be expected this requires significant time and effort and expertise to do correctly. Although automated or semi-automated mixing has been described such mixes are often perceived as being artificial sounding or otherwise do not provide the desired perceptual effect while listening. There is therefore a problem with such mixes as how to make the sources more realistic sounding or otherwise better when listened, for example, by adding suitable effects or processing.

The concept as described herein may be considered to be enhancement to conventional Spatial Audio Capture (SPAC) technology. Spatial audio capture technology can process audio signals captured via a microphone array into a spatial audio format. In other words generating an audio signal format with a spatial perception capacity.

The concept may thus be embodied in a form where audio signals may be captured such that, when rendered to a user, the user can experience the sound field as if they were present at the location of the capture device. Spatial audio capture can be implemented for microphone arrays found in mobile devices. In addition, audio processing derived from the spatial audio capture may be used employed within a presence-capturing device such as the Nokia OZO device.

In the examples described herein the audio signal is rendered into a suitable binaural form, where the spatial sensation may be created using rendering such as by head-related-transfer-function (HRTF) filtering a suitable audio signal.

The concept as described with respect to the embodiments herein makes it possible to capture and remix a close and environment audio signal more effectively and efficiently.

The concept may for example be embodied as a capture system configured to capture both a close (speaker, instrument or other source) audio signal and a spatial (audio field) audio signal. The capture system may furthermore be configured to determine or classify a source and/or the space within which the source is located. This information may then be stored or passed to a suitable rendering system which having received the audio signals and the information (source and space classification) may use this information to generate a suitable mixing and rendering of the audio signal to a user. Furthermore in some embodiments the render system may enable the user to input a suitable input to control the mixing, for example by use of a headtracking or other input which causes the mixing to be changed.

The concept furthermore is embodied by a broad spatial range capture device or an omni-directional content capture (OCC) device.

Although the capture, mixing/rendering and playback systems in the following examples are shown as being separate, it is understood that they may be implemented with the same apparatus or may be distributed over a series of physically separate but communication capable apparatus. For example, a presence-capturing device such as the Nokia OZO device could be equipped with an additional interface for analysing Lavalier microphone sources, and could be configured to perform the capture part. The output of the capture part could be a spatial audio capture format (e.g. as a 5.1 channel downmix), the Lavalier sources which are time-delay compensated to match the time of the spatial audio, and other information such as the classification of the source and the space within which the source is found.

In some embodiments the raw spatial audio captured by the array microphones (instead of spatial audio processed into 5.1) may be transmitted to the renderer, and the renderer perform spatial processing such as described herein.

The playback apparatus as described herein may be a set of headphones with a motion tracker, and software capable presenting binaural audio rendering. With head tracking, the spatial audio can be rendered in a fixed orientation with regards to the earth, instead of rotating along with the person's head.

Furthermore it is understood that at least some elements of the following capture and render apparatus may be implemented within a distributed computing system such as known as the ‘cloud’.

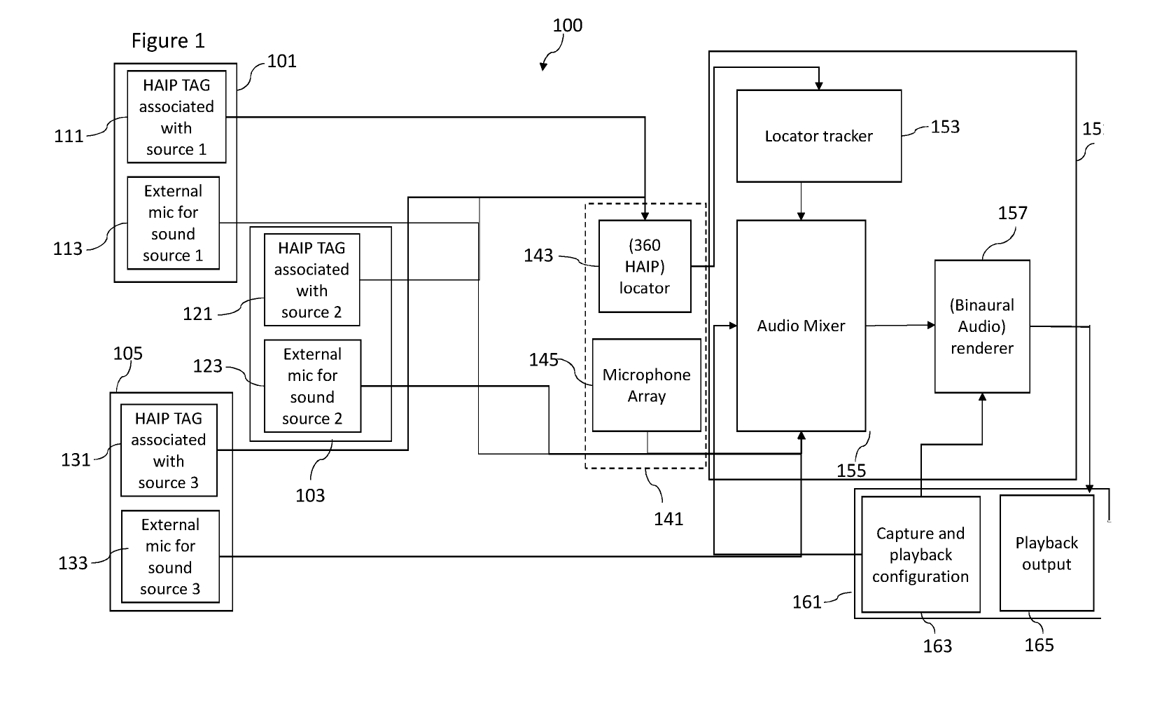

With respect to FIG. 1 is shown a system comprising local capture apparatus 101, 103 and 105, omni-directional content capture (OCC) apparatus 141, mixer/render 151 apparatus, and content playback 161 apparatus suitable for implementing audio capture, rendering and playback according to some embodiments.

In the following examples there is shown only three local capture apparatus 101, 103 and 105 configured to generate three local audio signals, however more than or fewer than 3 local capture apparatus may be employed.

The first local capture apparatus 101 may comprise a first external (or Lavalier) microphone 113 for sound source 1. The external microphone is an example of a ‘close’ audio source capture apparatus and may in some embodiments be a boom microphone or similar neighbouring microphone capture system.

Although the following examples are described with respect to an external microphone as a Lavalier microphone the concept may be extended to any microphone external or separate to the omni-directional content capture (OCC) apparatus. Thus the external microphones may be Lavalier microphones, hand held microphones, mounted mics, or whatever. The external microphones can be worn/carried by persons or mounted as close-up microphones for instruments or a microphone in some relevant location which the designer wishes to capture accurately. The external microphone 113 may in some embodiments be a microphone array.

A Lavalier microphone typically comprises a small microphone worn around the ear or otherwise close to the mouth. For other sound sources, such as musical instruments, the audio signal may be provided either by a Lavalier microphone or by an internal microphone system of the instrument (e.g., pick-up microphones in the case of an electric guitar).

The external microphone 113 may be configured to output the captured audio signals to an audio mixer and renderer 151 (and in some embodiments the audio mixer 155). The external microphone 113 may be connected to a transmitter unit (not shown), which wirelessly transmits the audio signal to a receiver unit (not shown).

Furthermore the first local capture apparatus 101 comprises a position tag 111. The position tag 111 may be configured to provide information identifying the position or location of the first capture apparatus 101 and the external microphone 113.

It is important to note that microphones worn by people can freely move in the acoustic space and the system supporting location sensing of wearable microphone has to support continuous sensing of user or microphone location. The position tag 111 may thus be configured to output the tag signal to a position locator 143.

In the example as shown in FIG. 1, a second local capture apparatus 103 comprises a second external microphone 123 for sound source 2 and furthermore a position tag 121 for identifying the position or location of the second local capture apparatus 103 and the second external microphone 123.

Furthermore a third local capture apparatus 105 comprises a third external microphone 133 for sound source 3 and furthermore a position tag 131 for identifying the position or location of the third local capture apparatus 105 and the third external microphone 133.

In the following examples the positioning system and the tag may employ High Accuracy Indoor Positioning (HAIP) or another suitable indoor positioning technology. In the HAIP technology, as developed by Nokia, Bluetooth Low Energy is utilized. The positioning technology may also be based on other radio systems, such as WiFi, or some proprietary technology. The indoor positioning system in the examples is based on direction of arrival estimation where antenna arrays are being utilized in 143.

There can be various realizations of the positioning system and an example of which is the radio based location or positioning system described here. The location or positioning system may in some embodiments be configured to output a location (for example, but not restricted, in azimuth plane, or azimuth domain) and distance based location estimate.

For example, GPS is a radio based system where the time-of-flight may be determined very accurately. This, to some extent, can be reproduced in indoor environments using WiFi signaling.

The described system however may provide angular information directly, which in turn can be used very conveniently in the audio solution.

In some example embodiments the location can be determined or the location by the tag can be assisted by using the output signals of the plurality of microphones and/or plurality of cameras.

The capture apparatus 101 comprises a broad spatial range capture or omni-directional content capture (OCC) apparatus 141. The following examples describe embodiments using the omni-directional content capture (OCC) apparatus 141 is an example of an ‘audio field’ capture apparatus. In some embodiments the omni-directional content capture (OCC) apparatus 141 may comprise a directional or omnidirectional microphone array 145. The microphone array may comprise a plurality of microphones arranged in a geometry such that the apparatus is configured to capture sound from pre-determined directions around the formed geometry. The pre-determined directions may comprise substantially from all directions. The omni-directional content capture (OCC) apparatus 141 may be configured to output the captured audio signals to the mixer/render apparatus 151 (and in some embodiments an audio mixer 155).

Furthermore the omni-directional content capture (OCC) apparatus 141 comprises a source locator 143. The source locator 143 may be configured to receive the information from the position tags 111, 121, 131 associated with the audio sources and identify the position or location of the local capture apparatus 101, 103, and 105 relative to the omni-directional content capture apparatus 141. The source locator 143 may be configured to output this determination of the position of the spatial capture microphone to the mixer/render apparatus 151 (and in some embodiments a position tracker or position server 153). In some embodiments as discussed herein the source locator receives information from the positioning tags within or associated with the external capture apparatus. In addition to these positioning tag signals, the source locator may use video content analysis and/or sound source localization to assist in the identification of the source locations relative to the OCC apparatus 141.

As shown in further detail, the source locator 143 and the microphone array 145 are co-axially located. In other words the relative position and orientation of the source locator 143 and the microphone array 145 is known and defined.

In some embodiments the source locator 143 is configured to receive the positioning locator tags from the external capture apparatus and furthermore determine the location and/or orientation of the OCC apparatus 141 in order to be able to determine a positon or location from the tag information with respect to the OCC apparatus location. Furthermore when the locators and microphone array are coaxial, the position can be also calculated as a relative position with respect to the media capture system. In other words the position determiner is with respect to the positioning locator system.

This for example may be used where there are multiple OCC apparatus 141 and thus external sources may be defined with respect to an absolute co-ordinate system.

In some embodiments the omni-directional content capture (OCC) apparatus 141 may implement at least some of the functionality within a mobile device.

The omni-directional content capture (OCC) apparatus 141 is thus configured to capture spatial audio, which, when rendered to a listener, enables the listener to experience the sound field as if they were present in the location of the spatial audio capture device.

The local capture apparatus comprising the external microphone in such embodiments is configured to capture high quality close-up audio signals (for example from a key person's voice, or a musical instrument).

The mixer/render apparatus 151 may comprise a position tracker (or position server) 153. The position tracker 153 may be configured to receive the relative positions from the omni-directional content capture (OCC) apparatus 141 (and in some embodiments the source locator 143) and be configured to output parameters to an audio mixer 155.

Thus in some embodiments the position or location of the OCC apparatus is determined. The location of the spatial audio capture device may be denoted (at time 0) as

(x_{S}(0), y_{S}(0))

In some embodiments there may be implemented a calibration phase or operation (in other words defining a 0 time instance) where one or more of the external capture apparatus are positioned in front of the microphone array at some distance within the range of an positioning locator. This position of the external capture (Lavalier) microphone may be denoted as

(x_{L}(0), y_{L}(0))

Furthermore in some embodiments this calibration phase can determine the ‘front-direction’ of the spatial audio capture device in the positioning coordinate system. This can be performed by firstly defining the array front direction by the vector

(x_{L}(0)−x_{S}(0), y_{L}(0)−y_{S}(0))

This vector may enable the position tracker to determine an azimuth angle α and the distance d with respect to the OCC and the microphone array.

For example given an external (Lavalier) microphone position at time t

(x_{L} (t), y_{L}(t))

The direction relative to the array is defined by the vector

(x_{L}(t)−x_{S}(0), y_{L}(t)−y_{S}(0))

The azimuth α may then be determined as

α=a tan 2(y_{L}(t)−y_{S}(0), x_{L}(t)−x_{S}(0))−a tan 2(y_{L}(0)−y_{S}(0), x_{L}(0) −x_{S}(0))

where a tan 2(y,x) is a “Four-Quadrant Inverse Tangent” which gives the angle between the positive x-axis and the point (x,y). Thus, the first term gives the angle between the positive x-axis (origin at x_{S}(0) and y_{S}(0)) and the point (x_{L}(t), y_{L}(t)) and the second term is the angle between the x-axis and the initial position (x_{L}(0), y_{L}(0)). The azimuth angle may be obtained by subtracting the first angle from the second.

The distance d can be obtained as

{square root over ((x_{L}(t)−x_{S}(0))²+(y(t)−y_{S}(0))²)}

In some embodiments, since the positioning location data may be noisy, the positions (x_{L}(0), y_{L}(0) and (x_{S}(0), y_{S}(0)) may be obtained by recording the positions of the positioning tags of the audio capture device and the external (Lavalier) microphone over a time window of some seconds (for example 30 seconds) and then averaging the recorded positions to obtain the inputs used in the equations above.

In some embodiments the calibration phase may be initialized by the OCC apparatus being configured to output a speech or other instruction to instruct the user(s) to stay in front of the array for the 30 second duration, and give a sound indication after the period has ended.

Although the examples shown above show the locator 145 generating location or position information in two dimensions it is understood that this may be generalized to three dimensions, where the position tracker may determine an elevation angle or elevation offset as well as an azimuth angle and distance.

In some embodiments other position locating or tracking means can be used for locating and tracking the moving sources. Examples of other tracking means may include inertial sensors, radar, ultrasound sensing, Lidar or laser distance meters, and so on.

In some embodiments, visual analysis and/or audio source localization are used to assist positioning.

Visual analysis, for example, may be performed in order to localize and track pre-defined sound sources, such as persons and musical instruments. The visual analysis may be applied on panoramic video which is captured along with the spatial audio. This analysis may thus identify and track the position of persons carrying the external microphones based on visual identification of the person. The advantage of visual tracking is that it may be used even when the sound source is silent and therefore when it is difficult to rely on audio based tracking. The visual tracking can be based on executing or running detectors trained on suitable datasets (such as datasets of images containing pedestrians) for each panoramic video frame. In some other embodiments tracking techniques such as kalman filtering and particle filtering can be implemented to obtain the correct trajectory of persons through video frames. The location of the person with respect to the front direction of the panoramic video, coinciding with the front direction of the spatial audio capture device, can then be used as the direction of arrival for that source. In some embodiments, visual markers or detectors based on the appearance of the Lavalier microphones could be used to help or improve the accuracy of the visual tracking methods.

In some embodiments visual analysis can not only provide information about the 2D position of the sound source (i.e., coordinates within the panoramic video frame), but can also provide information about the distance, which is proportional to the size of the detected sound source, assuming that a “standard” size for that sound source class is known. For example, the distance of ‘any’ person can be estimated based on an average height. Alternatively, a more precise distance estimate can be achieved by assuming that the system knows the size of the specific sound source. For example the system may know or be trained with the height of each person who needs to be tracked.

In some embodiments the 3D or distance information may be achieved by using depth-sensing devices. For example a ‘Kinect’ system, a time of flight camera, stereo cameras, or camera arrays, can be used to generate images which may be analyzed and from image disparity from multiple images a depth may or 3D visual scene may be created. These images may be generated by a camera.

Audio source position determination and tracking can in some embodiments be used to track the sources. The source direction can be estimated, for example, using a time difference of arrival (TDOA) method. The source position determination may in some embodiments be implemented using steered beamformers along with particle filter-based tracking algorithms.

In some embodiments audio self-localization can be used to track the sources.

There are technologies, in radio technologies and connectivity solutions, which can furthermore support high accuracy synchronization between devices which can simplify distance measurement by removing the time offset uncertainty in audio correlation analysis. These techniques have been proposed for future WiFi standardization for the multichannel audio playback systems.

In some embodiments, position estimates from positioning, visual analysis, and audio source localization can be used together, for example, the estimates provided by each may be averaged to obtain improved position determination and tracking accuracy. Furthermore, in order to minimize the computational load of visual analysis (which is typically much “heavier” than the analysis of audio or positioning signals), visual analysis may be applied only on portions of the entire panoramic frame, which correspond to the spatial locations where the audio and/or positioning analysis sub-systems have estimated the presence of sound sources.

Location or position estimation can, in some embodiments, combine information from multiple sources and combination of multiple estimates has the potential for providing the most accurate position information for the proposed systems. However, it is beneficial that the system can be configured to use a subset of position sensing technologies to produce position estimates even at lower resolution.

The mixer/render apparatus 151 may furthermore comprise an audio mixer 155. The audio mixer 155 may be configured to receive the audio signals from the external microphones 113, 123, and 133 and the omni-directional content capture (OCC) apparatus 141 microphone array 145 and mix these audio signals based on the parameters (spatial and otherwise) from the position tracker 153. The audio mixer 155 may therefore be configured to adjust the gain and spatial position associated with each audio signal in order to provide the listener with a much more realistic immersive experience. In addition, it is possible to produce more point-like auditory objects, thus increasing the engagement and intelligibility. The audio mixer 155 may furthermore receive additional inputs from the playback device 161 (and in some embodiments the capture and playback configuration controller 163) which can modify the mixing of the audio signals from the sources.

The audio mixer in some embodiments may comprise a variable delay compensator configured to receive the outputs of the external microphones and the OCC microphone array. The variable delay compensator may be configured to receive the position estimates and determine any potential timing mismatch or lack of synchronisation between the OCC microphone array audio signals and the external microphone audio signals and determine the timing delay which would be required to restore synchronisation between the signals. In some embodiments the variable delay compensator may be configured to apply the delay to one of the signals before outputting the signals to the renderer 157.

The timing delay may be referred as being a positive time delay or a negative time delay with respect to an audio signal. For example, denote a first (OCC) audio signal by x, and another (external capture apparatus) audio signal by y. The variable delay compensator is configured to try to find a delay T, such that x(n)=y(n−T). Here, the delay T can be either positive or negative.

The variable delay compensator may in some embodiments comprises a time delay estimator. The time delay estimator may be configured to receive at least part of the OCC audio signal (for example a central channel of a 5.1 channel format spatial encoded channel). Furthermore the time delay estimator is configured to receive an output from the external capture apparatus microphone 113, 123, 133. Furthermore in some embodiments the time delay estimator can be configured to receive an input from the location tracker 153.

As the external microphone may change its location (for example because the person wearing the microphone moves while speaking), the OCC locator 145 can be configured to track the location or position of the external microphone (relative to the OCC apparatus) over time. Furthermore, the time-varying location of the external microphone relative to the OCC apparatus causes a time-varying delay between the audio signals.

In some embodiments a position or location difference estimate from the location tracker 143 can be used as the initial delay estimate. More specifically, if the distance of the external capture apparatus from the OCC apparatus is d, then an initial delay estimate can be calculated. Any audio correlation used in determining the delay estimate may be calculated such that the correlation centre corresponds with the initial delay value.

In some embodiments the mixer comprises a variable delay line. The variable delay line may be configured to receive the audio signal from the external microphones and delay the audio signal by the delay value estimated by the time delay estimator. In other words when the ‘optimal’ delay is known, the signal captured by the external (Lavalier) microphone is delayed by the corresponding amount.

In some embodiments the mixer/render apparatus 151 may furthermore comprise a renderer 157. In the example shown in FIG. 1 the renderer is a binaural audio renderer configured to receive the output of the mixed audio signals and generate rendered audio signals suitable to be output to the playback apparatus 161. For example in some embodiments the audio mixer 155 is configured to output the mixed audio signals in a first multichannel (such as 5.1 channel or 7.1 channel format) and the renderer 157 renders the multichannel audio signal format into a binaural audio formal. The renderer 157 may be configured to receive an input from the playback apparatus 161 (and in some embodiments the capture and playback configuration controller 163) which defines the output format for the playback apparatus 161. The renderer 157 may then be configured to output the renderer audio signals to the playback apparatus 161 (and in some embodiments the playback output 165).

The audio renderer 157 may thus be configured to receive the mixed or processed audio signals to generate an audio signal which can for example be passed to headphones or other suitable playback output apparatus. However the output mixed audio signal can be passed to any other suitable audio system for playback (for example a 5.1 channel audio amplifier).

In some embodiments the audio renderer 157 may be configured to perform spatial audio processing on the audio signals.

The mixing and rendering may be described initially with respect to a single (mono) channel, which can be one of the multichannel signals from the OCC apparatus or one of the external microphones. Each channel in the multichannel signal set may be processed in a similar manner, with the treatment for external microphone audio signals and OCC apparatus multichannel signals having the following differences:

1) The external microphone audio signals have time-varying location data (direction of arrival and distance) whereas the OCC signals are rendered from a fixed location.
2) The ratio between synthesized “direct” and “ambient” components may be used to control the distance perception for external microphone sources, whereas the OCC signals are rendered with a fixed ratio.
3) The gain of external microphone signals may be adjusted by the user whereas the gain for OCC signals is kept constant.

The playback apparatus 161 in some embodiments comprises a capture and playback configuration controller 163. The capture and playback configuration controller 163 may enable a user of the playback apparatus to personalise the audio experience generated by the mixer 155 and renderer 157 and furthermore enable the mixer/renderer 151 to generate an audio signal in a native format for the playback apparatus 161. The capture and playback configuration controller 163 may thus output control and configuration parameters to the mixer/renderer 151.

The playback apparatus 161 may furthermore comprise a suitable playback output 165.

In such embodiments the OCC apparatus or spatial audio capture apparatus comprises a microphone array positioned in such a way that allows omnidirectional audio scene capture.

Furthermore the multiple external audio sources may provide uncompromised audio capture quality for sound sources of interest.

A determined or coaxial location of an omnidirectional position tracking system (such as implemented by the locator 143 which may employ an omni-directional positioning receiver or receiver array) may tracks the location or position of the external audio sources in 3D. This is achieved by attaching a tag to the person or instrument being tracked.

Furthermore as described in further detail hereafter, the OCC may be configured such that the determined ‘coaxial’ mounting or location of the locator 143 configured to perform position tracking and the microphone array 145 configured to perform spatial audio capture enables a common reference direction to be defined. In other words the OCC may comprise a mount or mounting structure which aligns the locator 143 and microphone array 145. Such a mount enables direct use of position tracking data with minimal transformation. The mount may also be known as other means such as ‘an apparatus element’, ‘a component’, ‘a chassis’, ‘a housing member’, ‘a housing component’. In some embodiments the mount may comprise mechanical coupling and electrical coupling means for coupling and aligning the plurality of microphones and locator.

The mixer/renderer 151 may thus be configured to perform spatial processing (SPAC) processing on all the signals from the microphone array. These processed signals may be subsequently processed to create a binaural downmix of the SPAC processed signals.

The locator 143 (such as the omni-directional positioning implementations shown herein) tracks the position of the external microphones in 3D space. The direction of arrival (DOA) and distance estimate based on received signal strength is used to determine the position of the external audio source. A stream of position information can be signaled by the locator, the position or location information being associated with the temporally corresponding external audio source signal.

The mixer 155 and renderer 157 may then mix and render the external sound sources into the correct azimuth, elevation and distance of a binaural audio mix. Subsequently the microphone array binaural downmix and the external audio sources binaural downmix may be combined to present the binaural audio representation for consumption.

In some embodiments as described herein the locator 143 and the OCC microphone array configured to perform spatial audio capture may have an elevation offset. This allows the locator apparatus to be externalized to the OCC apparatus, which provides benefits in terms of compactness and ease of manufacture.

In some embodiments as also described herein the tag used to indicate the location of the external microphone can itself be located at a known or defined offset from the actual external microphone position. For example, a vocal performer can wear the position tag as a locket or lanyard which is at an offset from the mouth, where the external microphone (e.g. a Lavalier microphone) is situated. This offset can be either configured into the capture system or signalled to the mixer and renderer.

In such a manner audio-visual content capture system which are co-axially co-located with an all aspect radio based active positioning system may provide an out of box distributed audio capture system.

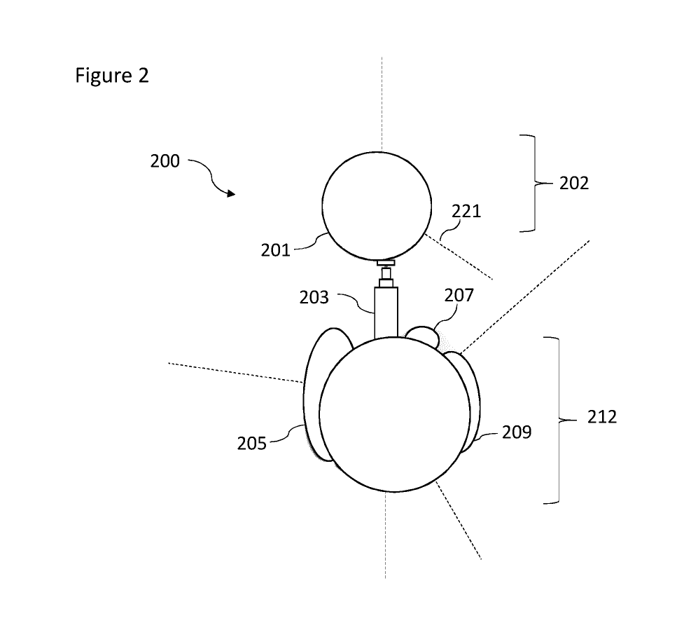

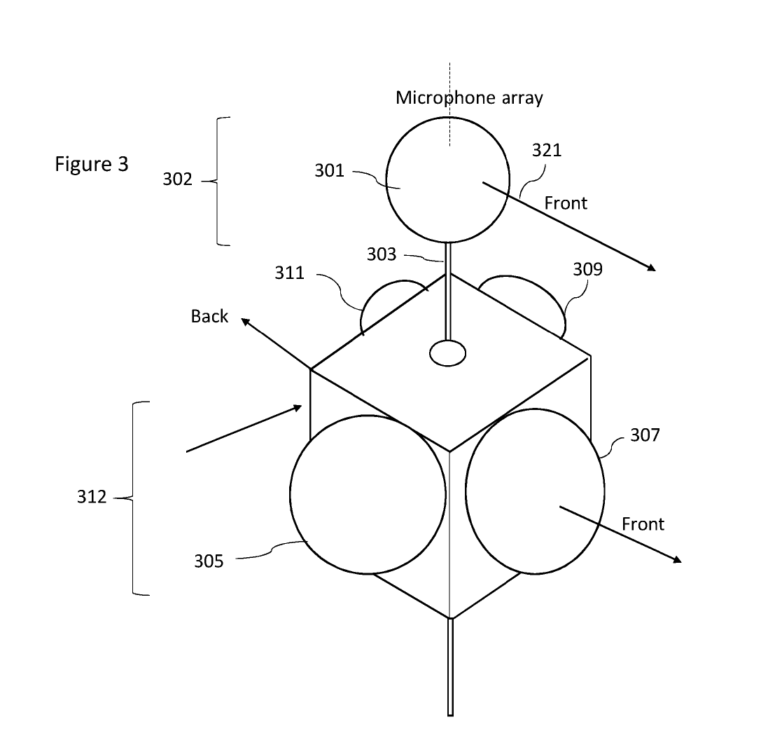

FIGS. 2 and 3 show example OCC apparatus. For example FIG. 2 shows a first example OCC apparatus 200. The OCC apparatus 200 comprises the microphone array part 202 comprising a microphone array 201. The microphone array may then be mounted on a fixed or telescopic mount 203 which locates the microphone array 201, with a ‘front’ or reference orientation 221 relative to a locator part 212. The OCC apparatus 200 further comprises a locator part 212. The locator part 212 in FIG. 2 shows an example of a 3 antenna positioning receiver array. Each array element 205, 207, 209 is located and orientated on the same elevation plane (for example centred on the horizontal plane) and positioned at separations of 120 degrees in azimuth from each other in order to provide 360 degree coverage with some overlap. In the example shown in FIG. 2 the reference orientation of the microphone array is coincidental with the reference orientation of one of the positioning receiver array elements. However in some embodiments the microphone reference orientation is defined relative to a reference orientation of one of the positioning receiver array elements.

Thus as can be seen in FIG. 2, the OCC apparatus comprises a co-axially located microphone array 202 and (the omnidirectional positioning) locator 212. The co-axial location as well as aligned reference axis of an omni-directional positioning system and the media capture system enable an out of box usage possibility. As the configuration shown herein may remove the need for any calibration or complicated setup.

FIG. 3 illustrates a similar system to the example shown in FIG. 2. The second example OCC apparatus 300 comprises the microphone array part 302 comprising a microphone array 301. The microphone array may then be mounted on a fixed or telescopic mount 203 which locates the microphone array 301, with a ‘front’ or reference orientation 321 relative to a locator part 312. The OCC apparatus 300 further comprises a locator part 312. The locator part 312 in FIG. 3 shows an example of a 4 antenna positioning receiver array. Each array element 305, 307, 309, 311 is located and orientated on the same elevation plane (for example centred on the horizontal plane) and positioned at separations of 90 degrees in azimuth from each other in order to provide 360 degree coverage with further overlap when compared to the example shown in FIG. 2. In the example shown in FIG. 3 the reference orientation of the microphone array is coincidental with the reference orientation of one of the positioning receiver array elements. However in some embodiments the microphone reference orientation is defined relative to a reference orientation of one of the positioning receiver array elements. The consequence of more locator array elements is an increased size of the OCC apparatus.

It is understood that the number and location and orientation of locator arrays and array elements can be configured based on the locator array antenna design and specification. A suitable array design may vary significantly from example to example, and can be based on the expected operational environment and the desired radio system to be used.

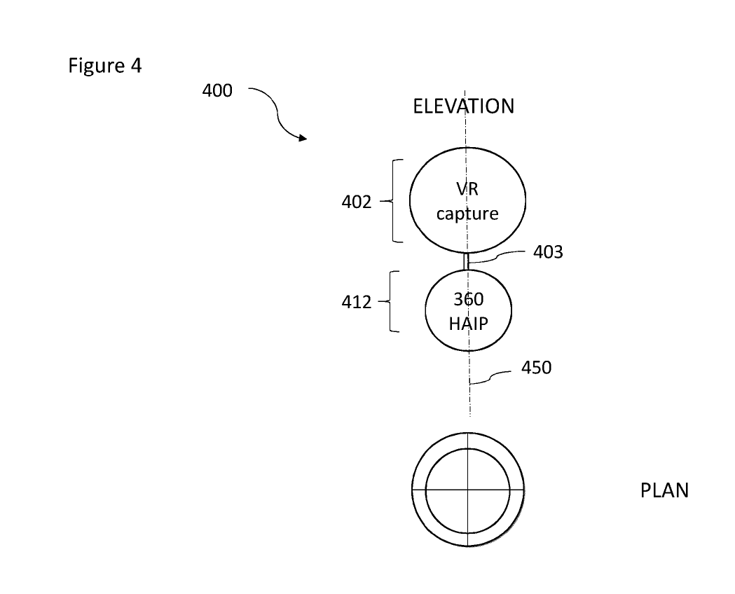

FIG. 4 shows an elevation and plan view of a schematic view of an example OCC apparatus. The OCC apparatus 400, in a manner similar to the examples shown in FIGS. 2 and 3 shows the example OCC apparatus 400 comprising the microphone array part 402 mounted on a fixed or telescopic mount 403 which locates the microphone array part 402, with a ‘front’ or reference orientation 321 relative to a locator part 412 and on a common (vertical) axis 450.

An advantage of such an apparatus is the location and placement of the positioning locator array. For distributed audio capture use scenarios, azimuth is of particular importance, since in most conventional audio capture scenarios, the elevation of any objects of interest do not move significantly. Hence locating the locator and microphone co-axially removes any possibility of azimuth error arising due to any lateral positioning offset between the microphone array and the locator (omni-directional positioning system).

Furthermore by employing an offset in the vertical plane has the main advantage that the locator is de-coupled from the microphone array or media capture system. This allows the positioning system to be coupled with different types of media capture apparatus (e.g. a different microphone array for spatial audio capture or a VR camera of different specifications).

Furthermore in some embodiments the decoupling enables a modular OCC design. For example the antenna array in the locator system can be easily replaced or re-designed for different usage scenarios. For example, for situations where a system with higher accuracy is needed, a bigger antenna array can be employed.

Locating the locator antenna array below the media capture (such as the array microphones) enables a greater coverage of the area as the blind spots in omnidirectional content capture devices can be reduced or moved to less significant regions.

Although in the examples shown in FIGS. 2 to 4 the microphone array part is located ‘above’ the locator (positioning antenna array) it is understood that the multimedia capture part such as the microphone array may be located ‘below’ the locator. Thus in some embodiments wherein the OCC apparatus is mounted on a flying or floating platform (for example drone content capture scenarios), the positioning apparatus position can be moved to be ‘above’ or as peripheral ring to the media capture apparatus. Such a setup is thus better optimized for look down content capture.

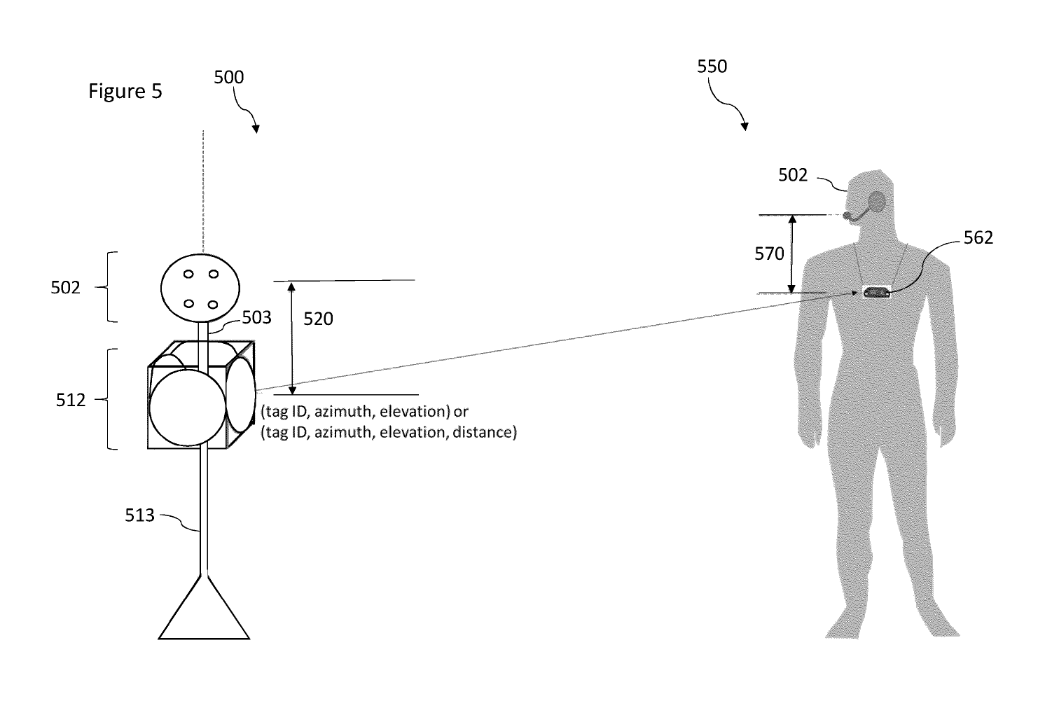

FIG. 5 shows an example where both the OCC apparatus and the external capture apparatus feature an elevation offset between the media capture (microphone) system and the locator (omnidirectional positioning) systems.

Thus the audio source, which in this example is a key speaker 550, is configured to wear the external capture apparatus in the form of a microphone 552 in a headset and position tag in a lanyard 562 worn about the neck. The elevation offset 570 between the external sound source microphone 552 and the associated lanyard 562 may be known and be transferred as an offset of the tracked position of the external microphone. This offset can transferred or not based on several implementation factors such as: the distance between the external microphones and the microphone array 502; the elevation offset 520 between the microphone array 502 and the locator 512 on the OCC 500; and the elevation offset 570 between external sound source 502 and the positioning tag 562.

Thus each external audio source of interest may be associated with a (positioning) locator tag, which transmits radio signals indicating its own position, which implicitly indicates the position of the external audio source. The microphone array which is aligned with the (positioning) locator receives an audio scene signal from its microphones. The microphone array and external audio source signals may then be combined and mixed in the audio mixer. The renderer may furthermore generate a binaural audio output which can be consumed in combination with a head tracker. Such a setup allows the user to consume binaural audio and experience the 3D audio scene with the help of a head tracker.

In some embodiments the playback or a configuration apparatus may provide a capture configuration interface which enable the operator of this system to configure the elevation offsets of the positioning system with respect to the microphone array and tag with respect to the actual audio source position. The playback configuration interface allows the content consumer to set the desired reference position.

In some embodiments of the invention, this system may be used in combination with visual content capture. In such a scenario, the visual content is further synchronised with the audio content. In addition, the head tracking of the immersive visual content is synchronised with the binaural audio playback head tracker.

The difference in delay in either the visual content pipeline or the audio content pipeline may result in out of synchronised playback experience. The playback configuration interface can be equipped to choose a suitable delay for audio, assuming the audio is leading the visual content playback. This will ensure a synchronized audio visual content playback experience.

The embodiments as described herein can be used in real time as well as for post-production scenarios. In case of real-time usage, the location (positioning) data is transmitted over a suitable real time protocol such as UDP and used in real-time with very small delay (of the order of few milliseconds).

In post-production embodiments the tag location (positioning UDP) data may be received while capturing audio data and stored in a file. In some embodiments the apparatus may create separately timestamped log files for audio data as well as location (positioning) data. The latter option can be used easily when the location tracker or location server and audio recording server (the mixer) have synchronized their clocks with network time protocol or any suitable method.

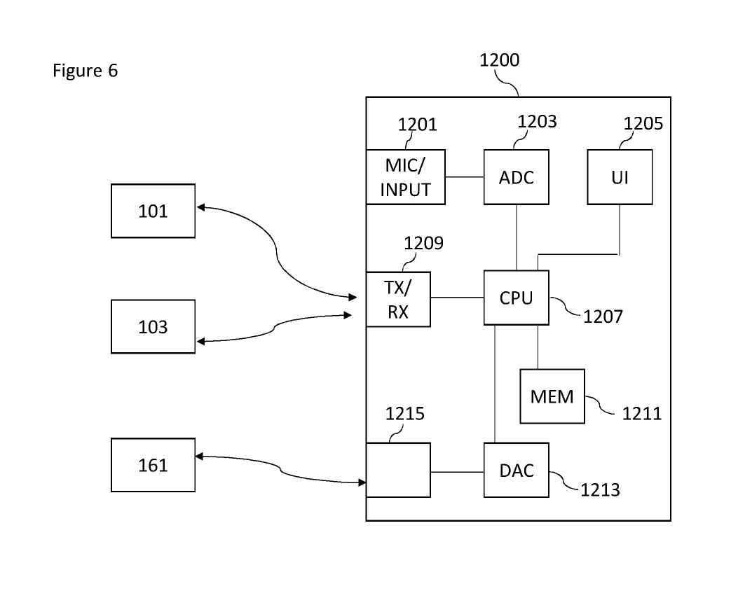

With respect to FIG. 6 an example electronic device which may be used as at least part of the external capture apparatus 101, 103 or 105 or OCC capture apparatus 141, or mixer/renderer 151 or the playback apparatus 161 is shown. The device may be any suitable electronics device or apparatus. For example in some embodiments the device 1200 is a mobile device, user equipment, tablet computer, computer, audio playback apparatus, etc.

The device 1200 may comprise a microphone array 1201. The microphone array 1201 may comprise a plurality (for example a number N) of microphones. However it is understood that there may be any suitable configuration of microphones and any suitable number of microphones. In some embodiments the microphone array 1201 is separate from the apparatus and the audio signals transmitted to the apparatus by a wired or wireless coupling. The microphone array 1201 may in some embodiments be the microphone 113, 123, 133, or microphone array 145 as shown in FIG. 1.

The microphones may be transducers configured to convert acoustic waves into suitable electrical audio signals. In some embodiments the microphones can be solid state microphones. In other words the microphones may be capable of capturing audio signals and outputting a suitable digital format signal. In some other embodiments the microphones or microphone array 1201 can comprise any suitable microphone or audio capture means, for example a condenser microphone, capacitor microphone, electrostatic microphone, Electret condenser microphone, dynamic microphone, ribbon microphone, carbon microphone, piezoelectric microphone, or microelectrical-mechanical system (MEMS) microphone. The microphones can in some embodiments output the audio captured signal to an analogue-to-digital converter (ADC) 1203.

The device 1200 may further comprise an analogue-to-digital converter 1203. The analogue-to-digital converter 1203 may be configured to receive the audio signals from each of the microphones in the microphone array 1201 and convert them into a format suitable for processing. In some embodiments where the microphones are integrated microphones the analogue-to-digital converter is not required. The analogue-to-digital converter 1203 can be any suitable analogue-to-digital conversion or processing means. The analogue-to-digital converter 1203 may be configured to output the digital representations of the audio signals to a processor 1207 or to a memory 1211.

In some embodiments the device 1200 comprises at least one processor or central processing unit 1207. The processor 1207 can be configured to execute various program codes. The implemented program codes can comprise, for example, SPAC control, position determination and tracking and other code routines such as described herein.

In some embodiments the device 1200 comprises a memory 1211. In some embodiments the at least one processor 1207 is coupled to the memory 1211. The memory 1211 can be any suitable storage means. In some embodiments the memory 1211 comprises a program code section for storing program codes implementable upon the processor 1207. Furthermore in some embodiments the memory 1211 can further comprise a stored data section for storing data, for example data that has been processed or to be processed in accordance with the embodiments as described herein. The implemented program code stored within the program code section and the data stored within the stored data section can be retrieved by the processor 1207 whenever needed via the memory-processor coupling.

In some embodiments the device 1200 comprises a user interface 1205. The user interface 1205 can be coupled in some embodiments to the processor 1207. In some embodiments the processor 1207 can control the operation of the user interface 1205 and receive inputs from the user interface 1205. In some embodiments the user interface 1205 can enable a user to input commands to the device 1200, for example via a keypad. In some embodiments the user interface 205 can enable the user to obtain information from the device 1200. For example the user interface 1205 may comprise a display configured to display information from the device 1200 to the user. The user interface 1205 can in some embodiments comprise a touch screen or touch interface capable of both enabling information to be entered to the device 1200 and further displaying information to the user of the device 1200.

In some implements the device 1200 comprises a transceiver 1209. The transceiver 1209 in such embodiments can be coupled to the processor 1207 and configured to enable a communication with other apparatus or electronic devices, for example via a wireless communications network. The transceiver 1209 or any suitable transceiver or transmitter and/or receiver means can in some embodiments be configured to communicate with other electronic devices or apparatus via a wire or wired coupling.

For example as shown in FIG. 6 the transceiver 1209 may be configured to communicate with a playback apparatus 103.

The transceiver 1209 can communicate with further apparatus by any suitable known communications protocol. For example in some embodiments the transceiver 209 or transceiver means can use a suitable universal mobile telecommunications system (UMTS) protocol, a wireless local area network (WLAN) protocol such as for example IEEE 802.X, LTE, a suitable short-range radio frequency communication protocol such as Bluetooth, or infrared data communication pathway (IRDA).

In some embodiments the device 1200 may be employed as a render apparatus. As such the transceiver 1209 may be configured to receive the audio signals and positional information from the capture apparatus 101, and generate a suitable audio signal rendering by using the processor 1207 executing suitable code. The device 1200 may comprise a digital-to-analogue converter 1213. The digital-to-analogue converter 1213 may be coupled to the processor 1207 and/or memory 1211 and be configured to convert digital representations of audio signals (such as from the processor 1207 following an audio rendering of the audio signals as described herein) to a suitable analogue format suitable for presentation via an audio subsystem output. The digital-to-analogue converter (DAC) 1213 or signal processing means can in some embodiments be any suitable DAC technology.

Furthermore the device 1200 can comprise in some embodiments an audio subsystem output 1215. An example, such as shown in FIG. 6, may be where the audio subsystem output 1215 is an output socket configured to enabling a coupling with the headphones 161. However the audio subsystem output 1215 may be any suitable audio output or a connection to an audio output. For example the audio subsystem output 1215 may be a connection to a multichannel speaker system.

In some embodiments the digital to analogue converter 1213 and audio subsystem 1215 may be implemented within a physically separate output device. For example the DAC 1213 and audio subsystem 1215 may be implemented as cordless earphones communicating with the device 1200 via the transceiver 1209.

Although the device 1200 is shown having both audio capture and audio rendering components, it would be understood that in some embodiments the device 1200 can comprise just the audio capture or audio render apparatus elements.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims.

However, all such and similar modifications of the teachings of this invention will still fall within the scope of this invention as defined in the appended claims.

1. Apparatus comprising:
a plurality of microphones arranged in a geometry around a first axis such that the apparatus is configured to capture sound from pre-determined directions around the formed geometry;
a locator configured to receive at least one remote location signal such that the apparatus may locate an audio source associated with a tag generating the remote location signal, the locator comprising an array of antenna elements, the antenna elements being arranged around the first axis; and
a mount configured to mechanically couple the plurality of microphones and the locator.

2. The apparatus as claimed in claim 1, wherein the mount is configured to provide an offset perpendicular to the first axis between the plurality of microphones and the locator.

3. The apparatus as claimed in claim 2, wherein the mount is a telescopic mount configured to adjustably change the offset perpendicular to the first axis.

4. The apparatus as claimed in claim 2, wherein the plurality of microphones are arranged in a first ring around the first axis, the locator comprising the antenna elements arranged in a second ring around the first axis, wherein the first ring is one of:
located above the second ring;
located below the second ring; and
located inside the second ring.

5. The apparatus as claimed in claim 1, wherein the plurality of microphones are arranged in a first ring around the first axis, the locator comprising the antenna elements arranged in a second ring around the first axis, wherein the first ring is located outside the second ring.

6-7. (canceled)

8. The apparatus as claimed in claim 1, wherein the plurality of microphones is further configured to have a first reference orientation and the locator is further configured to have a second reference orientation, wherein the mount is configured to define an orientation offset between the first reference orientation and the second reference orientation.

9. The apparatus as claimed in claim 8, wherein the mount is configured to align the first reference orientation and the second reference orientation.

10. The apparatus as claimed in claim 1, wherein the locator comprising the array of antenna elements are configured to produce a 360 degree azimuth coverage around the first axis.

11. The apparatus as claimed in claim 1, wherein the plurality of microphones are configured to produce a 360 degree azimuth coverage around the first axis.

12. The apparatus as claimed in claim 1, wherein the tag is associated with at least one remote microphone configured to generate at least one of:
at least one remote audio signal from the audio source, wherein the apparatus is configured to receive the remote audio signal; and
an external audio signal from the audio source, wherein the apparatus is configured to transmit the audio source location to a further apparatus.

13. (canceled)

14. A method comprising:
providing a plurality of microphones arranged in a geometry around a first axis such that the microphones are configured to capture sound from predetermined directions around the formed geometry;
providing a locator for receiving at least one remote location signal, and locating an audio source associated with a tag generating the remote location signal, the locator comprising an array of antenna elements, the antenna elements being arranged around the first axis; and
providing a mount configured to mechanically couple the plurality of microphones and the locator.

15. The method as claimed in claim 14, wherein the mount is configured to provide an offset perpendicular to the first axis between the plurality of microphones and the locator.

16. The method as claimed in claim 15, wherein the mount is a telescopic mount configured to adjustably change the offset perpendicular to the first axis.

17. The method as claimed in claim 15, further comprising arranging the plurality of microphones in a first ring around the first axis, arranging the antenna elements in a second ring around the first axis, wherein the first ring is one of:
located above the second ring;
located below the second ring; and
located inside the second ring.

18. The method as claimed in claim 14, further comprising arranging the plurality of microphones in a first ring around the first axis, arranging the antenna elements in a second ring around the first axis, wherein the first ring is located outside the second ring.

19-20. (canceled)

21. The method as claimed in claim 14, wherein the plurality of microphones is further configured to have a first reference orientation and the locator is further configured to have a second reference orientation, wherein the mount is configured to at least one of:
define an orientation offset between the first reference orientation and the second reference orientation; and
align the first reference orientation and the second reference orientation.

22. (canceled)

23. The method as claimed in claim 14, wherein the locator comprising the array of antenna elements are configured to produce a 360 degree azimuth coverage around the first axis.

24. The method as claimed in claim 14, wherein the tag is associated with at least one remote microphone configured to generate at least one remote audio signal from the audio source, wherein the method comprises at least one of:
receiving the remote audio signal; and
transmitting the audio source location to a further apparatus.

25. (canceled)

26. The apparatus as claimed in claim 1, wherein the apparatus further comprises a plurality of cameras configured to assist the locator to at least one of: track and locate the audio source.

27. The method as claimed in claim 14, wherein the method further comprising a plurality of cameras configured to assist the locator to at least one of: track and locate the audio source.
